(19) United States
(12) Patent Application Publication
(10) Pub. No.: US 2008/0296410 A1
(43) Pub. Date: Dec. 4, 2008

(54) One piece airless spray gun housing

(75) Inventors: Danuta Helena Carey, Stockholm, NJ (US); Christopher Michael Walsh, Florham Park, NJ (US); John Michael Plocic, Sparta, NJ (US); John Richard Crane, Rahway, NJ (US)

Correspondence Address: BUCKNAM AND ARCHER, 1077 NORTHERN BOULEVARD, ROSLYN, NY, 11576, US

(73) Assignee: TriTech Industries, Inc.

(21) Appl. No.: 11/809,290

(22) Filed: May 31, 2007

(51) Int. Cl. B05B 7/02

(52) U.S. Cl. 239/526; 29/890.07

(57) ABSTRACT

There is provided an airless spray gun housing for an airless spray gun adapted to hydraulically atomize and spray paint wherein the spray gun housing includes a barrel portion and a handle portion, the spray gun housing being a unitary construction wherein the barrel portion and handle portion are integral with each other so that no joint or seam exists between the barrel portion and the handle portion.

### FIELD OF THE INVENTION

The present invention relates generally to hydraulically operated or airless paint spray guns and, more particularly, it relates to an improved airless spray gun housing which simplifies the construction of the spray gun and decreases the spray gun's potential to leak during use thus rendering the spray gun more practicable and safer to use.

### BACKGROUND OF THE INVENTION

Hydraulic or airless paint spray guns operate on the principle of creating a paint spray pattern suitable for painting by passing paint at high pressure through a small orifice or nozzle disposed at the forward end of the spray gun resulting in atomization of the paint. The pressure at which such spray guns operate is generally about 3000 psi and can be as high as 7500 psi. Obviously, at such high operating pressures, the possibility of leakage at any of the joints in the apparatus is always present. Furthermore, any such leaks can pose a physical danger to the operator of the spray gun because of the high pressure involved.

Heretofore, airless paint spray gun housings have been constructed in essentially two pieces, a barrel portion and a handle portion connected to the barrel portion. The barrel portion of the spray gun includes a spray tip at its forward end, a longitudinal passageway for delivering the high pressure paint to the spray tip, and means within the passageway operated by a trigger for controlling the volume and extent of the paint spray emitted by the spray tip or nozzle. The handle portion is attached, usually by means of threaded engagement, to a lower part of the barrel portion so as to be gripped by the painting operator whereby to direct the paint spray and operate the trigger. The high pressure paint is generally introduced to the spray gun by means of a high pressure hose connected by means of a swivel coupling to the lower end of the handle. The high pressure paint passes through an elongated filter in the handle and is directed to the passageway in the barrel portion and thus to the spray tip or nozzle. Access to the filter for service or replacement, is gained by removal of the handle portion from the barrel portion for most designs.

It can be easily understood that, because of the extremely high pressure involved, any joint or coupling in the paint delivery system is highly susceptible to leakage. Likewise, it can be appreciated that the elimination of any joint or coupling in the paint delivery system eliminates any possibility of leakage thereat.

### SUMMARY OF THE INVENTION

It is a primary object of the present invention to provide an improved airless paint spray gun which is simpler in design and less likely to leak the high pressure paint passing therethrough and is thus more practicable and effective than heretofore.

The above object is accomplished in accordance with the present invention by providing an airless paint spray gun wherein the barrel portion and handle portion of the spray gun body or housing are formed integrally or in one piece. The barrel portion of the spray gun housing is provided with a passageway terminating in a spray tip or nozzle at the distal end of the barrel portion and the handle portion is provided with a passageway intersecting the passageway in the barrel portion. The passageway in the handle portion houses an elongated filter for the paint passing therethrough and communicates with a source of high pressure paint. Thus, by constructing the spray gun housing in one piece, the resulting spray gun is simpler in construction and the joint or seam between the barrel portion and the handle portion is eliminated thereby eliminating the possibility of leakage thereat.

### BRIEF DESCRIPTION OF THE DRAWINGS

The present invention will be described and understood more readily when considered together with the accompanying drawings in which:

FIG. 1 is a side elevational view of an airless paint spray gun according to the prior art;

FIG. 2 is a cross sectional view of the prior art airless paint spray gun of FIG. 1;

FIG. 3 is an exploded view of another prior art airless paint spray gun;

FIG. 4 is a cross sectional view of an airless paint spray gun incorporating the one piece paint spray gun housing according to the present invention;

FIG. 5 is a cross sectional view of the one piece airless paint spray gun housing according to the present invention; and

FIG. 6 is an exploded view of the airless paint spray gun of FIG. 4.

### DETAILED DESCRIPTION OF THE INVENTION

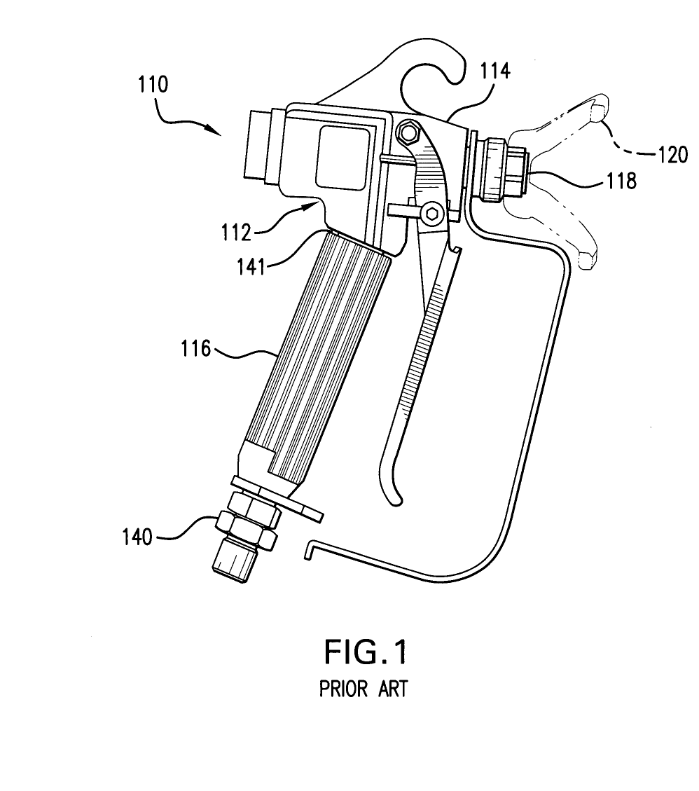

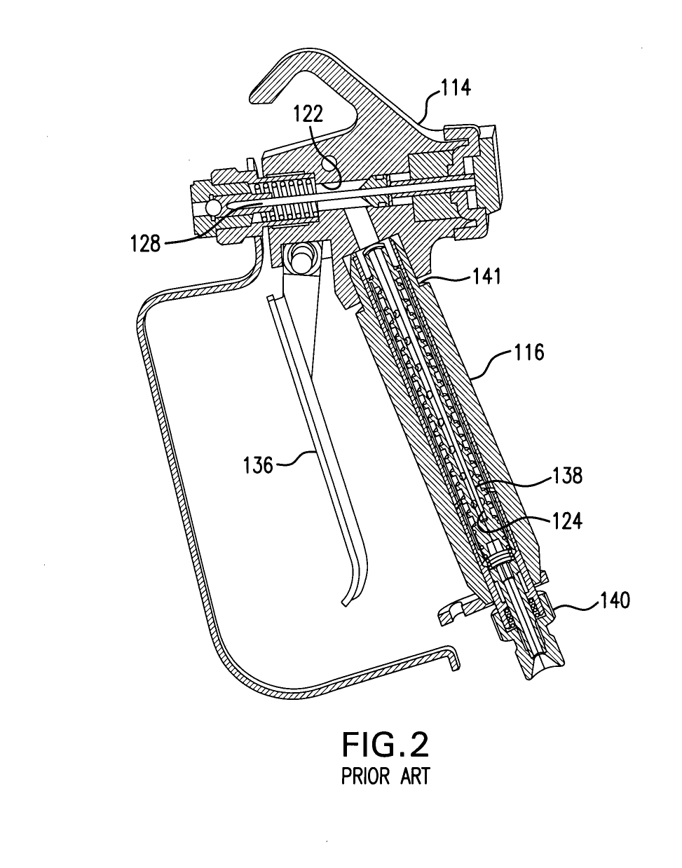

Now turning to the drawings, there is shown in FIG. 1 a typical prior art airless paint spray gun, designated 110, wherein the housing 112 includes a barrel portion 114 and a handle portion 116. At the distal end of barrel portion 114, a spray tip or nozzle 118 including a tip guard 120 (shown in phantom) are attached to the spray gun. Tip guard 120 includes a pair of forwardly extending wings which prevent the spray tip from inadvertently coming too close to a body part and possibly resulting in accidental injection of the body part with the stream of high pressure paint initially exiting the spray tip. A swivel coupling, designated 140, is attached to the end of handle portion 116 to which is connected a high pressure hose (not shown) which delivers the paint under high pressure to the spray gun. FIG. 2 shows a cross-sectional view of the prior art airless spray gun 110 of FIG. 1 wherein an elongated filter 138 is housed in passageway 124 of handle portion 116. Passageway 124 intersects passageway 122 which extends through barrel portion 114 and which houses needle assembly 128 actuated by trigger 136. Activation by trigger 136 withdraws needle assembly 128 in passageway 122 to cause high pressure paint to flow from the high pressure hose connected to swivel coupling 140 through elongated filter 138, passageway 122 and diffuser 134 and impinge upon spray tip 118 to be atomized suitable for spray painting. As clearly seen in FIGS. 1 and 2, handle portion 116 of spray gun housing 112 is a separate element from barrel portion 114 and is advantageously threadedly connected thereto resulting in a joint or seam 141 between the handle and barrel portions. The handle portion 116 of such a prior art airless spray gun is typically formed from extruded aluminum tubing which has its exterior machined by the spray gun manufacturer to form the spray gun handle. As can be appreciated, joint 141 is located in close proximity to the normal positioning of the user's hand during operation so that in the event any leak develops at the joint, there is the danger of injection of the user's hand by the high pressure paint.

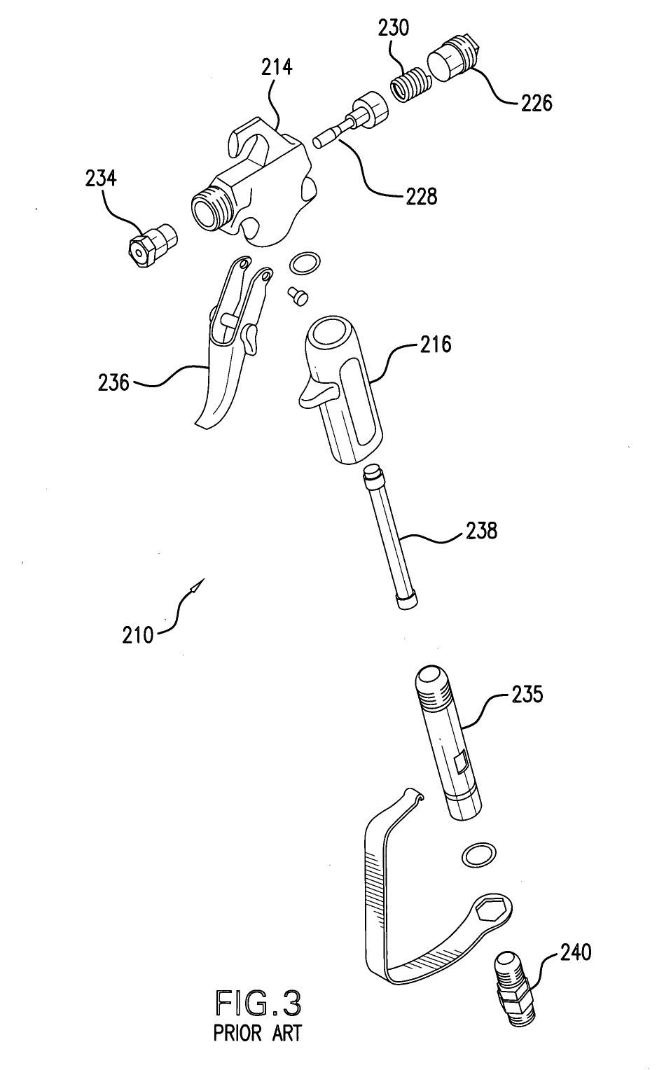

FIG. 3 is an exploded view of another prior art airless paint spray gun, designated 210, wherein the housing includes a barrel portion 214 and a handle portion 216. Barrel portion 214 houses a needle assembly 228, spring 230, end cap 226 and diffuser 234. A spray tip and tip guard (not shown) are attached to the distal end of barrel portion 214 in front of diffuser 234. Handle portion 216 houses a pipe like handle element 235 which is threadedly engaged with barrel portion 214 resulting in a joint or seam similar to joint 141 of spray gun 110. Handle element 235 has inserted therein elongated filter 238. Swivel coupling 240 is threadedly secured to handle element 235 and delivers high pressure paint thereto from a high pressure hose (not shown). Handle portion 216 may be aligned on the gun and secured to handle element 235 by means of a set screw (not shown). Typically, handle element 235 is formed from extruded aluminum tubing as is the case with handle portion 116 of prior art airless spray gun 110 of FIGS. 1 and 2. As in spray gun 110, the extruded aluminum tubing is machined by the spray gun manufacturer to create the final form of handle element 235.

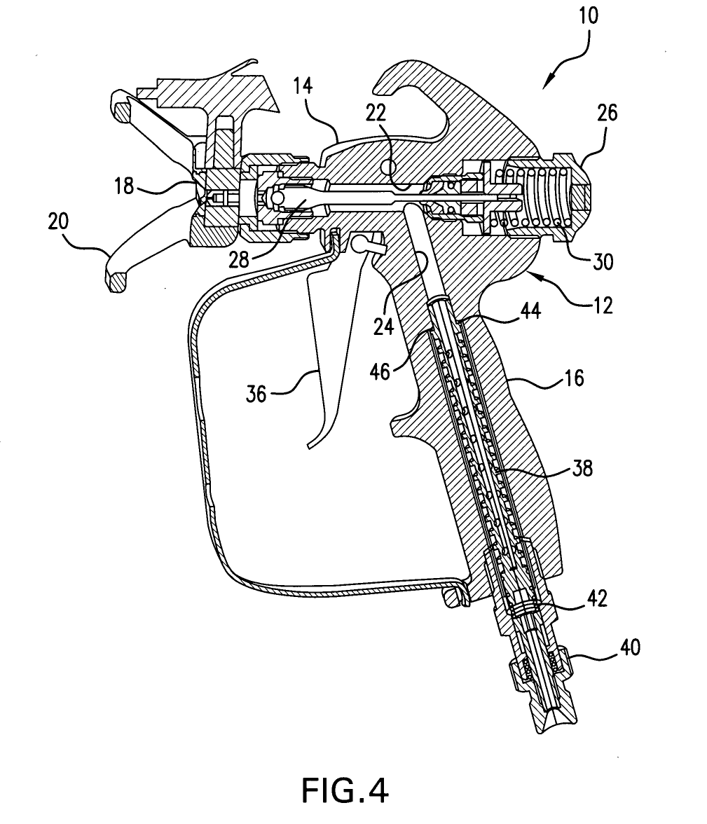

Now turning to the present invention, there is shown in FIG. 4 an airless paint spray gun, generally designated 10, including a housing 12 having a barrel portion 14 and a handle portion 16 depending from the barrel portion. At the distal end of barrel portion 14 a spray tip or nozzle 18 including a tip guard 20 are attached to the spray gun. A longitudinally oriented passageway, designated 22, is arranged in barrel portion 14 which is intersected by passageway 24 extending through handle portion 16. Passageway 22 extends throughout the length of barrel portion 14 and is capped at the rear end thereof by threaded end cap or nut 26 and terminates at the distal end thereof at spray tip 18. A control needle assembly, designated 28, is disposed in passageway 22 for controlling the spray of paint issuing from spray tip 18. The needle of needle assembly 28 is biased by spring 30 to seat on and obstruct the bore 32 of diffuser 34 thereby preventing high pressure paint reaching spray tip 18 until the needle assembly is withdrawn by trigger 36. An elongated filter, designated 38, is disposed in passageway 24 for the purpose of filtering the paint which passes through passageway 24 on its way to passageway 22 and spray tip 18. Paint is supplied to spray gun 10 via a high pressure hose (not shown) connected to swivel coupling 40 at the base of handle portion 16 which in turn communicates with passageway 24 in the handle portion. A spring, designated 42, disposed between swivel coupling 40 and filter 38 biases filter 38 so that shoulder 44 thereof engages step 46 in passageway 24. In this way all the paint introduced to passageway 24 must pass through filter 38.

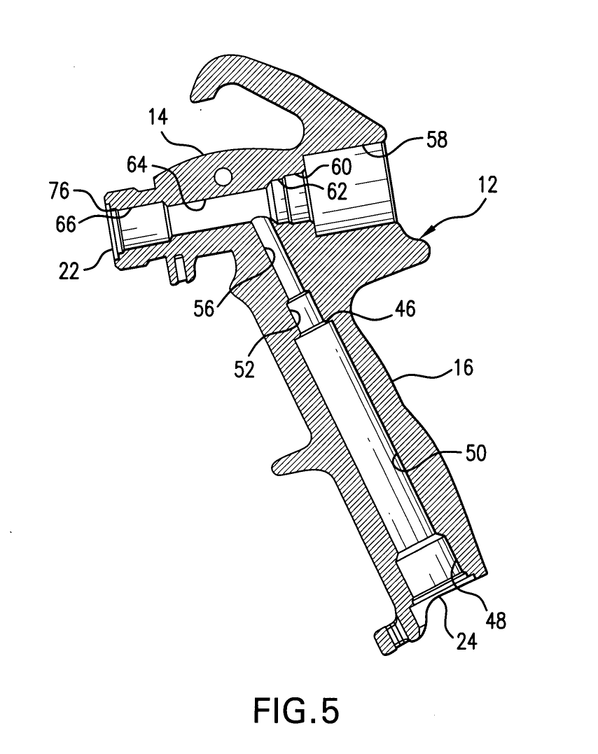

FIG. 5 is a cross-sectional view of the spray gun housing 12 of FIG. 1 and clearly shows that handle 16 is integrally formed with barrel 14 resulting in a one piece housing. Such a one piece construction is possible by using through-the-tool coolant drilling technology to produce passageway 24. Through-the-tool coolant drilling causes drilling chips to be removed from the work by means of high pressure coolant passing through the center of the drill and forcing the chips along the flutes of the drill and out of the drilled hole. Through-the-tool coolant drilling is utilized where the length of the drilled hole is long compared to its diameter, as is the case of passageway 24. Through-the-tool coolant drilling permits removal of potentially damaging chips and heat as the drill feeds deeper into the hole thus allowing high speed drilling and deeper holes. Passageway 24 comprises four stepped bores. The first, designated 48 accommodates swivel coupling 40, the second and longest, designated 50, accommodates elongated filter 38, the third, designated 52, accommodates the necked-in top end 54 of filter 38, and the fourth, designated 56, intersects with passageway 22 in barrel 14. Step 46 is defined by the different diameters of bores 50 and 52.

Passageway 22 in barrel portion 14 comprises a series of stepped relatively short bores commencing with bore 58 at the rear of barrel portion 14 for accommodating end cap 26 and spring 30, bores 60, 62 and 64 accommodate needle assembly 28, and bore 66 accommodates diffuser 34.

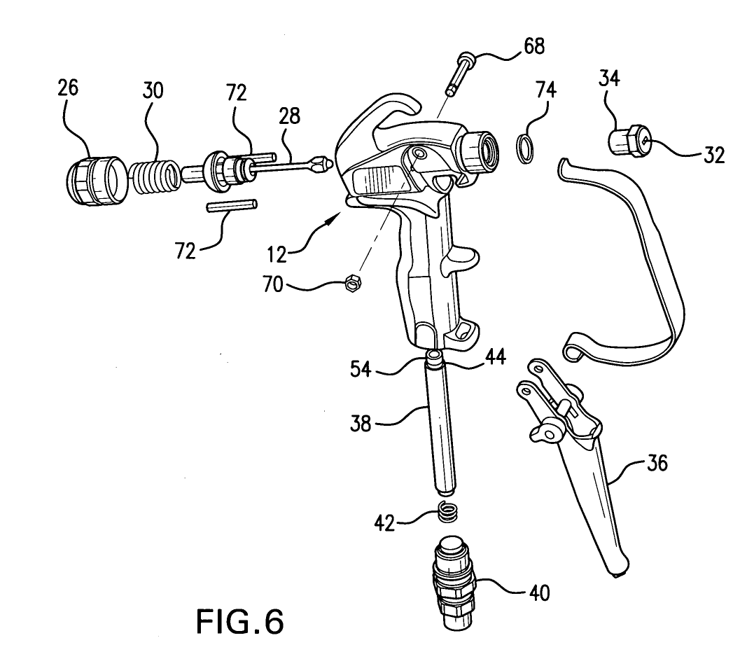

FIG. 6 is an exploded view of spray gun 10 showing the various internal elements of the spray gun arranged in relationship to the spray gun housing 12. As clearly seen, pivot pin 68 and nut 70 serve to secure trigger 36 to housing 12. Pins 72 are housed in chambers (not shown) in housing 12 to be acted on by trigger 36 to retract needle assembly 28 against the biasing action of spring 30 to uncover bore 32 in diffuser 34 and permit the high pressure paint to impinge on spray tip 18 and be sprayed therefrom. Seal 74 seats against the head of diffuser 34 and seat 76 in bore 66 to seal the outer rim of diffuser 34 against leakage. As clearly seen in FIG. 6, elongated filter 38 is inserted into passageway 24 of handle portion 16 from the open bottom thereof and shoulder 44 of filter 38 is biased against step 46 in passageway 24 by spring 42 which is disposed between filter 38 and swivel coupling 40.

As a result of forming housing 12 in one piece, the resulting spray gun 10 is formed of fewer parts and is therefor simpler and easier to manufacture as well as being safer because of the elimination of the seam or joint between the handle and barrel portions of the spray gun.

While only a single embodiment of the present invention has been shown and described, it will be obvious that many changes and modifications may be made thereto without departing from the spirit and scope of the present invention.

What is claimed is:

1. In an airless spray gun adapted to hydraulically atomize and spray paint, the spray gun having a housing including a barrel portion and a handle portion, wherein the barrel portion has a passageway extending therethrough housing a spring biased needle assembly activated by a trigger, an end cap closing a first end of said passageway, and a spray tip at a second end of said passageway disposed at the distal end of the barrel portion, and wherein the handle portion has a passageway extending therethrough intersecting at a first end with the passageway in said barrel portion and at a second end communicating with a source of high pressure paint, said handle portion passageway housing an elongated filter between said first and second ends thereof, the improvement comprising said spray gun housing being a unitary construction wherein said barrel portion and said handle portion are integral with each other.

2. A one piece housing for an airless spray gun adapted to hydraulically atomize and spray paint, said one piece housing comprising:
(a) a barrel portion having a passageway therethrough adapted to be closed at a first end and to terminate in a spray tip at a second end disposed at the distal end of said barrel portion, said barrel portion being adapted to house a spring biased needle assembly in said passageway activated by a trigger to permit the delivery of high pressure paint to said spray tip; and
(b) a handle portion integrally formed with said barrel portion having a passageway therethrough intersecting at a first end thereof with the passageway in said barrel portion and a second end thereof adapted to communicate with a source of high pressure paint, said handle portion being adapted to house in said passageway between said first and second ends thereof an elongated filter for filtering the paint passing therethrough.

3. A method of making a one piece spray gun housing for an airless spray gun adapted to hydraulically atomize and spray paint, said method comprising:
a) forming a spray gun housing blank including a barrel portion and an integral handle portion;
(b) forming a through passageway in said barrel portion adapted to accommodate an end cap at a first end thereof, a spring biased needle assembly activated by a trigger, and a spray tip at a second end thereof disposed at the distal end of said barrel portion; and
(c) forming a passageway extending through said handle portion intersecting at a first end thereof with the passageway in said barrel portion and adapted to communicate with a source of high pressure paint at a second end thereof and to accommodate therein between said first and second ends an elongated filter for filtering the high pressure paint supplied to said spray gun, said handle portion passageway being formed by through-the-tool coolant drilling.
